(19) United States
(12) Patent Application Publication
(10) Pub. No.: US 2008/0051989 A1
(43) Pub. Date: Feb. 28, 2008

(54) FILTERING OF DATA LAYERED ON MAPPING APPLICATIONS

(75) Inventor: Ricky D. Welsh, Duvall, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/467,442

(22) Filed: Aug. 25, 2006

(51) Int. Cl. G01C 21/32; G09G 5/00

(52) U.S. Cl. 701/208; 345/634

(57) ABSTRACT

Provided is a mapping application that displays detailed data information as a function of multiple sets of layered data. When portions of at least two sets of layered data overlap, a set operation is applied to the overlapping portions to create a new set of layered data. The set operation allows the sets of layered data to be modified utilizing a simple function, such as by dragging and dropping a set of layered data to a different portion of the map area. When the portions no longer overlap, the set operation is removed, rendering the sets of layered data in their original format.

### BACKGROUND

Mapping function have become common and interaction with such mapping functions can be user specific (e.g., the user can view a desired area of interest by entering information relating to the position or placement of the area of interest). Computing devices are commonly utilized to provide users a means to communicate and stay “connected” while moving from place to place. Technology of such mobile computing devices has advanced to the point where data regarding any desired content is readily available. For example, many people utilize mapping technologies to view areas of interest, such as a hometown or vacation spot, to obtain driving directions, or for a variety of other reasons.

Mapping applications offer a user a means to readily view geographical as well as other data relating to locations on the earth or elsewhere (e.g., moon, planets, stars, virtual places, and so forth) the user desires to view. There is a tremendous amount of data available for viewing in the mapping application. For example, a user is able to “zoom in” to view a small section of a map area (e.g., one city block) or “zoom out” to view the entire world, or a subset thereof. The zoomed in version of the map area can contain various detailed information, such as names of streets, rivers, buildings, data relating to temperature, driving directions, etc. When the mapping application is zoomed out to a larger viewing area (e.g. an entire state), it is not feasible to display detailed information such as street names due to system and display constraints, as well as the enormous amount of data available. Thus, displayed data at a zoomed out level might simply include state names, names of major highways, or major cities.

Mapping applications can have many different types of data overlaid on top of each other in layers. Filtering and displaying this data has typically been accomplished by turning on and off different layers of data or displaying different map styles, such as political, road, or night styles. When switching between layers or styles, the user needs to remember the different types of data in order to make a comparison between the different views. This can be difficult and frustrating. In addition, the user may wish to view different information for different areas or sections of the display space at substantially the same time. However, since the layers are turned on or off for the entire display area, the user is not able to view different information for different map areas.

Therefore, to overcome the aforementioned as well as other deficiencies, what is needed is a visual filtering system for data layered on a mapping application. Such data layering should be manipulated and displayed in a simple manner while allowing a user to modify different areas of the display as desired. The user should be provided a simple user interface to interact with a large amount of data layers in a visual and intuitive way.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with visual filters of data layered on mapping applications. The innovation can allow a user to interact with a multitude of data layers contained in a mapping application in a visual and intuitive manner. Such interaction can be in the form of applying a specified set operation (union, difference, intersection) to data contained in overlapping portions of two or more sets of filtered data. The filtered data can be specified by the user and can include one or more mapping layers (e.g., aerial map style, road map style, weather, traffic, search results, live web cams, external structure of a building, and so on). Each set of filtered data can overlay the mapping application and can be rendered in a separate portion of the display area and can further overlay other sets of filtered data. The filtered data can be any shape or size, which can be selectively modified. Temporal parameters can be selected and applied to the filtered data.

According to some embodiments a variety of data, including a combination of data layers, filters, display masks and set operations, can be managed in a multitude of ways and the resulting product displayed. A user can modify a filter to display any number of layers by, for example, dragging and dropping such layers onto a display mask. The user can further modify a display by dragging filters over each other. The intersected area of the display masks reveals a user chosen operation on the data displayed. The physical shape or size of the display mask can be modified. Value ranges provided with the metadata of the data being displayed can be adjusted, as desired.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates an exemplary system for layering data on a mapping application.

FIG. 2 illustrates an exemplary system that facilitates configuration of map layers and automatically displays data layers in an overlapping portion of at least two filters in a predefined manner.

FIG. 3 illustrates an exemplary screen shot of mapping application display masks utilizing the one or more embodiments disclosed herein.

FIG. 4 illustrates an exemplary data layer union operation on a display mask intersection area.

FIG. 5 illustrates an exemplary system that employs machine learning which facilitates automating one or more features in accordance with the disclosed embodiments.

FIG. 6 illustrates a methodology for displaying layered data in a mapping application.

FIG. 7 illustrates another methodology for layering data on a mapping application.

FIG. 8 illustrates a block diagram of a computer operable to execute the disclosed embodiments.

FIG. 9 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

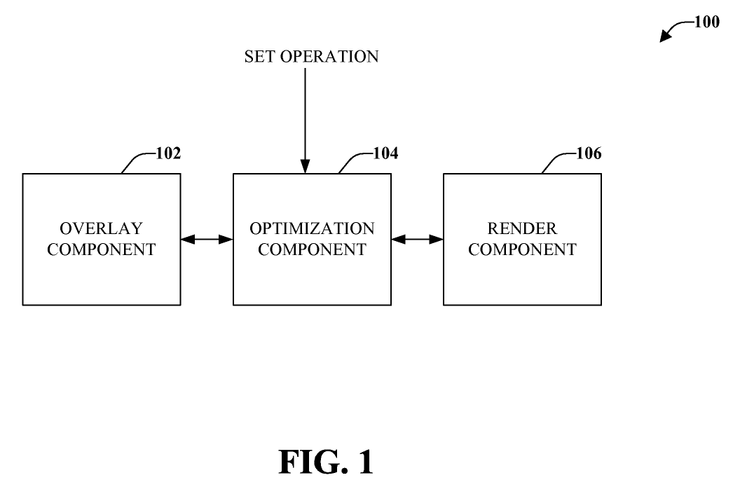

Referring initially to FIG. 1, illustrated is an exemplary system 100 for layering data on a mapping application. System 100 includes an overlay component 102, an optimization component 104, and a render component 106 that interface to layer map data as a set of filters that can interact and produce a new filter when placed in an overlapping configuration. System 100 can be located, for example on a client machine or a remote machine, which can be a computing device, either stationary or mobile.

Overlay component 102 can be configured to overlay portions of at least two sets of filtered data. In a mapping application, there are a multitude of data layers and the filtered data can comprise one or more data layers. The data layers can be data that is received by the mapping application in separate data streams of different files. Examples of data layers include aerial map style, road map style, weather, traffic, live web cams, landmarks or points of interest, three-dimensional structures, search results, yellow pages, mashups, and so on.

Each set of filtered data (filter) can be placed, either completely or partially, on top of each other, in any combination, to render a “complete picture” of what the user is interested in viewing. It should be noted that the filters can completely overlay each other or a subset of a filter can overlay a subset of one or more filter. To create different grouping of layers, any number of filters can be created and enabled or disabled by the user as desired. In addition, the filters can be named or identified.

Each filter can be rendered to the display screen (e.g., by render component 106) in its own separate area on the screen. Each separate area on the displayed map can be referred to as a “display mask”. Each display mask can be any shape or size and different display masks in the same mapping application can be different in shape and size. In such a manner the mapping application can be viewing in window or display area. There are also are display masks in that window or viewing area that display the layers defined by the filters for each mask. Further information regarding display masks operating in a mapping application are provided below.

Optimization component 104 can be configured to identify a specified Boolean or set operation and apply that set operation to the overlaid portions of the two or more sets of filtered data. The set operation can be a union, a difference, and an intersection, as well as other Boolean operations. The user can define the set operation to be utilized between two or more display masks. Such defined set operations can be predefined, selected when two or more display masks are overlaid, or changed as the user's utilization of the data changes. In accordance with some embodiments, system 100 can automatically display a user prompt requesting which set operation should be performed on the overlapping portions.

In addition or alternatively, optimization component 104 can apply a temporal setting on the data layers, as defined by the user. For example, a temporal setting can be adjusted on the images to only display data taken from 2004 to 2006 within the display mask. In this way, the user can view the temporal (as well as other defined display mask information) by moving the display mask over the area of interest instead of switching the layers of the entire map. In such a manner, optimization component 104 can apply a temporal setting independently to a first set of filtered data and a second set of filtered data

Render component 106 can be configured to render a display of the data in the overlapping portions as a function of the Boolean or set operation. The portions of the display masks that are not overlapping do not have the set operation applied. In such a manner, the portions of the display data that do not overlap are viewed with the original defined layers of data. However, as the display masks are moved and portions of display masks overlap each other, the layered data changes as defined by the set operation.

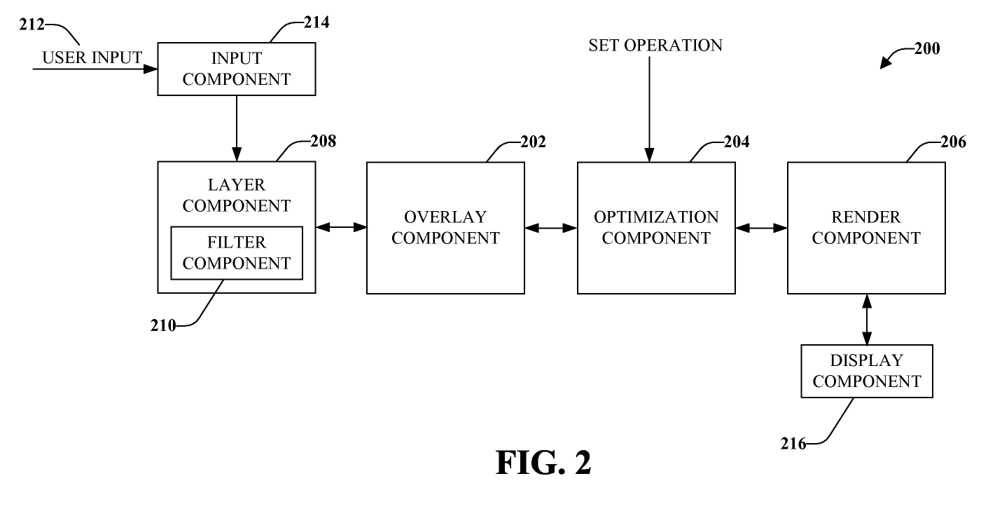

FIG. 2 illustrates an exemplary system 200 that facilitates configuration of map layers and automatically displays data layers in an overlapping portion of at least two filters in a predefined manner. System 200 can be located on a client machine or on a machine remote from the client. System 200 includes an overlay component 202 that overlays at least a portion of a first set of filtered data with at least a portion of at least a second set of filtered data. Also included is an optimization component 204 that applies a set operation to the overlaid portions of the first set of filtered data and the at least a second set of filtered data and a render component 206 that renders data in the overlapping portions as a function of the set operation.

System 200 also includes a layer component 208 that can be configured to distinguish between the various data layers associated with the mapping application. As the data layers are received by the mapping application, layer component 208 can identify such layers based on an identification scheme, such as a naming convention, a numbering sequence, or the like.

Layer component 208 can be associated with a filter component 210. It should be understood that while filter component 210 is illustrated as a component included in layer component 208, in accordance with some embodiments, filter component 210 can be a separate component. A user can define those layers that should be included in each display mask and filter component 210 can be configured to apply or assign the data layers to the display mask. In addition, filter component 210 can modify a display mask upon receiving a user request to change the type and number of layers contained in each display mask. Such changes can occur at any time including after the display mask is defined.

Filter component 210 can be configured to maintain or store the defined display mask in a retrievable format, such as in a storage media (not shown). The information for the layers can remain on a client machine while the mapping data is received from a server that can be located remote from the client machine, however other configurations are possible. By way of illustration, and not limitation, storage media can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The filter component can receive the user input 212 through an interface with an input component 214 that can be configured to provide various types of user interfaces. For example, input component 214 can provide a graphical user interface (GUI), a command line interface, a speech interface, Natural Language text interface, and the like. For example, a GUI can be rendered that provides a user with a region or means to load, import, select, read, etc. the one or more display masks, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate choosing which data layers to include in each display mask, such as vertical and/or horizontal scroll bars for navigation and toolbar buttons to determine whether a region will be viewable can be employed. For example, the user can interact with the one or more display masks, data layers, or both by entering the information into an edit control.

The user can interact with the data layers and display masks to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an display mask name or data layer name provided in the interface prompt or an answer to a question posed in the prompt (e.g., “Do you want to include (delete) Data Layer X from Display Mask Y?” or “Do you want to create (remove) Display Mask Z?”). It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

As one or more display masks are position or moved over one or more other display masks, such as through a drag and drop action, overlay component 202 identifies the portions of each display mask that are overlaid. Optimization component 204 can perform a set operation to the portions of each display mask that are overlaid. The performed set operation creates a new filter on the portions of the display mask that are overlapping while the remaining portions of the display masks (those not overlapping another display mask) maintain their originally defined filters (e.g., chosen data layers for that display mask). Thus, optimization component 204 can be configured to perform the set operation to the overlapping portions without affecting the portions of the display mask that are not overlaid.

If two or more display masks overlay a particular display mask, or a subset thereof, optimization component 204 can be configured to apply different set operations to the different areas of the display mask that are overlaid. Thus, a display mask can have one or more set operation applied to different sub-portions of the display mask. In addition, if two or more display masks overlay a portion of another display mask, the set operations are performed on each mask in a predefined order. It should be noted that the order of an operation may affect the outcome of the operation.

Render component 206 can interface with a display component 216 to display the map including the display masks and the results of a set operation applied to overlapping portions of two or more display masks. It should be understood that while display component 216 is shown as a separate component, in accordance with some embodiments, it can be included as a component of render component 206 or another system 200 component.

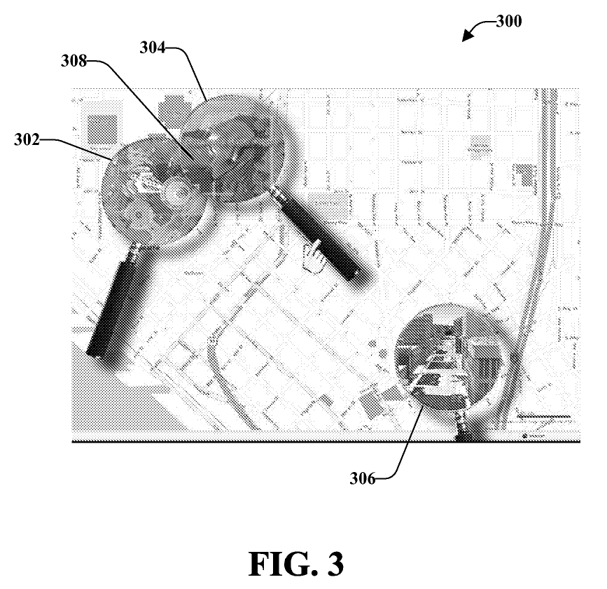

FIG. 3 illustrates an exemplary screen shot 300 of mapping application display masks utilizing the one or more embodiments disclosed herein. Three different display masks 302, 304, and 306 are illustrated in the screen shot and are geo-located. The term geo-located can refer to visual layers and layers that are not visual, such as audio. It should be understood that while the display masks 302, 304, 306 are illustrated inside magnifying glasses, they can be presented in a multitude of forms and the shapes and sizes can differ between display masks in the same displayed map area. Various display masks can be turned on (displayed in the map area) or turned off (not displayed in the map area). In addition, while the various embodiments disclosed herein are discussed with reference to a mapping applications, such embodiments can also apply to various other applications, such as Simulations, Virtual Worlds, Gaming, Social Networks, and other systems that employ geo-located data.

Each illustrated mask 302, 304, and 306 is displaying different layers of data. A layer can include data (e.g., audio, text, imagery, Radar, Lidar, Infrared). A first mask 302 is displaying Aerial Map Style images from a mapping application and, as shown, is providing a view of the Space Needle. The second mask 304 is showing Bird's Eye imagery as one layer and labeling (“Experience Music Project”) as another layer in the same mask. The third mask 306 is showing another set of layers, which are three-dimensional buildings or street-side information. Each mask 302, 304, 306 can be thought of as “boring a hole” through the base road map style, which provides the location relationship of the masks 302, 304, 306, and, therefore, the layers contained or displayed within each mask 302, 304, 306.

The masks 302, 304, 306 can be moved around the display area by the user selecting a mask and dragging and dropping it on a particular area of the screen. The information viewed in a display masks changes as it is moved in the map area in order to reflect the portion of the map where it is located. The display masks 302, 304, 306 can also be moved by the user selecting the mask and specifying a coordinate on the display area that indicates where to move the mask, however, other techniques for moving the masks can be employed with the disclosed embodiments. Display masks can be positioned over top of each other, as shown by the first display mask 302 and the second display mask 304, the overlapping portion is indicated at 308. The positioning of the masks 302, 404 allow a set operation to be performed on the layers of data and on the display masks.

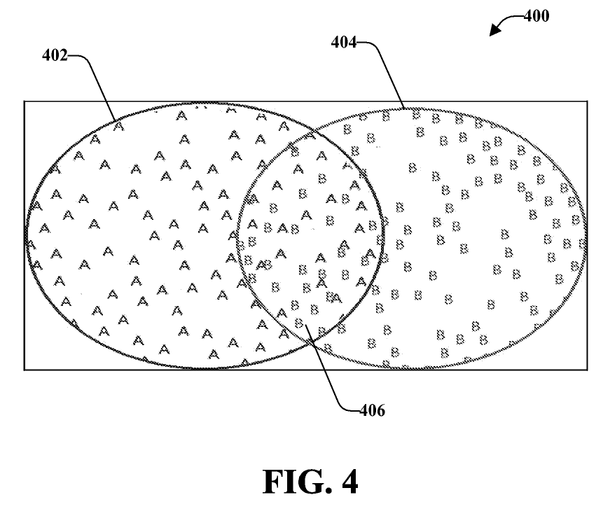

Set operation as utilized herein is associated with the intersection or overlapping portions of the shape defined for the mask area. The user can choose the operation to apply, however, the order of an operation may affect the outcome of the operation. The result of the operation on the layer data is displayed on the common area 308 of overlapping display masks 302, 304. Further detail regarding the set operation on the overlapping portions of display masks is provided with reference to FIG. 4.

By way of example and not limitation, three filters can be created, which are “My Night on the Town”, “My Business Travel”, and “My Extras”. There can be ten layers associated with the mapping application, which can be: Layer 1, Aerial Map Style; Layer 2, Road Map Style; Layer 3, Weather; Layer 4, Traffic; Layer 5, Live Web Cams; Layer 6, Points of Interest; Layer 7, Three-Dimensional Structures; Layer 8, Search Results (searched for hotels, for example); Layer 9, Yellow Pages; Layer 10, Mashups (e.g. jogging trails). Examples of filters for these layers can be, for example:

Filters:
1. My night on the Town:
   a. Layer 1, Aerial Map Style
   b. Layer 3, Weather
   c. Layer 4, Traffic
   d. Layer 7, Three-Dimensional Buildings
   e. Layer 9, Yellow Pages
2. My Business Travel:
   a. Layer 2, Road Map Style
   b. Layer 3, Weather
   c. Layer 6, Points of Interest
   d. Layer 8, Search Results (searched for hotels, for example)
3. My Extras:
   a. Layer 5, Live Web Cams
   b. Layer 10, Mashups (Jogging trails)
   c. Layer 7, Three-Dimensions Buildings

Each of the above layers can be placed on top of each other, in any combination. Filters associated with each layer can be named and enabled or disabled by the user. In addition filters can be modified and new filters can be created.

FIG. 4 illustrates an exemplary data layer union operation on a display mask intersection area. A first display mask “A” filter 402 contains several layers of data and a second display mask “B” filter 404 contains another set of layer data. Although a number of display masks can be overlapping, only two masks are shown for simplicity purposes. The intersected area 406 of the two display masks 402, 404 results in a new filter when an area set operation is applied. A user can choose the operation to apply to the overlapping portion 406. Such operations include a union operation, a subtraction operation, an intersection operation, as well as other Boolean operations.

For exemplary purposes and not limitation, display mask “A” filter 402 can represent the filter “My Night out on the Town” and display mask “B” filter 404 can represent the filter “My Extras”. Further, each display mask 402, 404 contains the following layers.

My Night on the Town:
Aerial Map Style
Weather
Traffic
Three-dimensional Buildings
Yellow Pages

My Extras
Live Web Cams
Mashups, jogging trails
Three-dimensional Buildings

If the user chooses a union operation (A∪B) on the layer data, the display in the overlapping area 406 shows data from both “My Night on the Town” and layer data of “My Extras”. The display for the overlapping area 406 will show the following data layers after the operation is applied:

Aerial Map Style

Weather

Traffic

Three-dimensional Buildings

Yellow Pages

Live Web Cams

Mashups, jogging trails

If the user had selected a subtraction operation (A−B), the displayed overlapping layers would be as follows:

Aerial Map Style

Weather

Traffic

Yellow Pages

If the user had selected an intersection operation (A∩B), the displayed overlapping layers are as follows:

Three-Dimensional Buildings

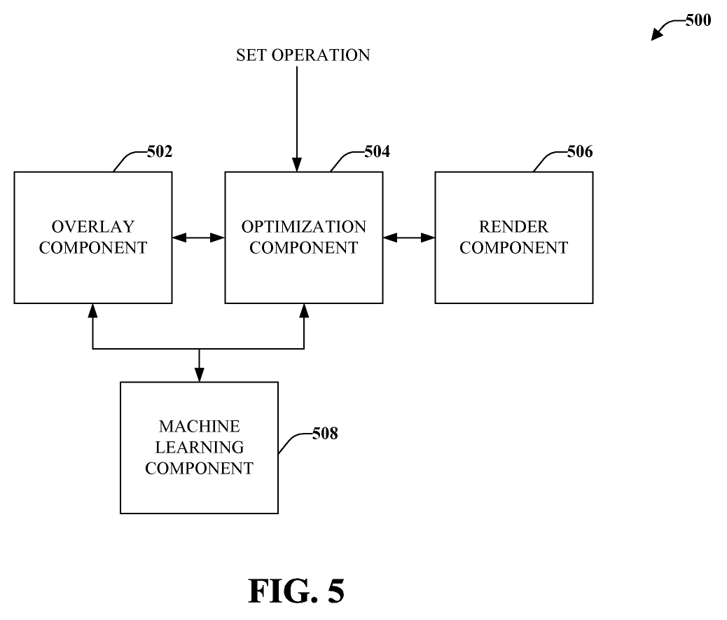

FIG. 5 illustrates an exemplary system 500 that employs machine learning which facilitates automating one or more features in accordance with the disclosed embodiments. Machine learning based systems (e.g., explicitly and/or implicitly trained classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

The various embodiments (e.g., in connection with creating one or more display masks and performing a set operation on overlapping portions of two or more display masks) can employ various artificial intelligence (AI) based schemes for carrying out various aspects thereof. For example, a process for determining if a new data layer should be included in a display mask can be facilitated through an automatic classifier system and process. Moreover, where multiple display masks are employed having the same or similar data layers, the classifier can be employed to determine which display mask to employ in a particular situation or whether a particular display mask should be deleted or renamed.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of data layers, for example, attributes can be words or phrases or other data-specific attributes derived from the words (e.g., naming convention, identification scheme), and the classes are categories or areas of interest (e.g. levels of detail).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g. through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to access through a call, the type of data, the importance of the data, etc.

In accordance with some embodiments, the machine learning component can be an implementation scheme (e.g., rule, rules-based logic component) and can be applied to control and/or regulate display masks and associated data layers. It will be appreciated that the rules-based implementation can automatically and/or dynamically regulate a set operation and an order of one or more set operations based upon a predefined criterion. In response thereto, the rule-based implementation can automatically create a new filter from overlapping portions of two or more data masks by employing a predefined and/or programmed rule(s) based upon any desired set operation or multiple set operations.

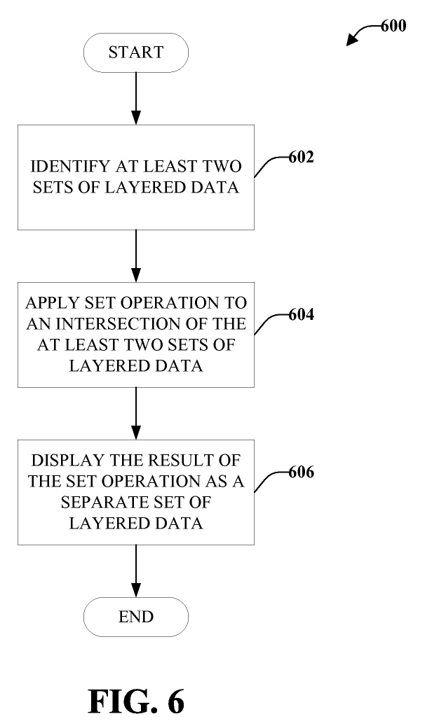

In view of the exemplary systems shown and described above, methodologies that may be implemented in accordance with the disclosed subject matter, will be better appreciated with reference to the flow charts of FIGS. 6-8. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates a methodology 600 for displaying layered data in a mapping application. Method 600 starts, at 602, when at least two sets of layered data are identified. The two sets of layered data can be filters or display masks that comprise at least one data layer. Such display masks can be configured by a user and activated (displayed on the screen) or deactivated (not displayed on the screen). The display masks that are deactivated are not capable of being identified in a current session, unless such mask is activated.

At 604, a set operation is applied to an intersection of the at least two sets of layered data. The set operation can be a Boolean operation and can include a union of layers between two or more display masks, a subtraction of layers between two or more display masks, or an intersection operation on the layers of two or more display masks.

At 606, the intersection of the at least two sets of layered data is displayed based in part on the applied set operation. The intersection is displayed as a separate set of layered data based in part on the applied set operation. For example, if a union set operation is applied, the overlapping or intersecting portion of the two sets of layered data would include all the layers of both sets. If a subtraction set operation is applied, the overlapping portion would display the non-common data layers. That is to say if both layers contain a common data layer and a subtraction set operation is applied, the common data layers would cancel and would not be displayed in the overlapping portion. If an intersection set operation is applied, the overlapping portion would display the common data layers between the two (or more) sets of layered data. When the two or more sets of layered data are no longer overlapping (e.g., when a user moves one or more set), and there is no longer an intersection, the set operation of the intersection is automatically removed and the sets of layered data return to their predefined condition.

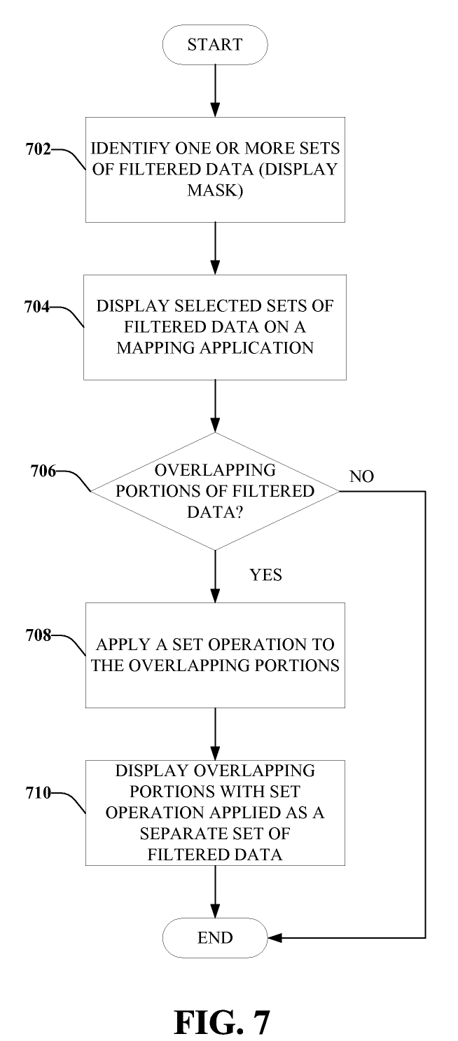

FIG. 7 illustrates another methodology 700 for layering data on a mapping application. Method starts at 702, where one or more sets of filtered data (display mask) are identified. A user can specify which data layers should be included in each set of filtered data. At 704, selected sets of filtered data are displayed on a mapping application. The selected sets of data are those that are activated (turned on) in a map application. Sets of data that are defined, but not activated, are not viewed in the map area. In such a manner, the user can specify a desired set of data to view and, without having to switch layers of the entire map, can move the desired set of data (display mask) over the area of interest.

A determination is made, at 706, whether there are overlapping portions of filtered data. Such a determination can be made at substantially the same time as a user moves at least a portion of a set of layered data over another portion of a second set of layered data. For example, the user can select a first display mask utilizing the mouse and “drag” that mask around the map area and “drop” the mask at a different portion of the map area.

If there are no overlapping portions of filtered data (“NO”), the masks are displayed as data layers without any set operation performed. If the determination, at 706, is that there are overlapping portions of filtered data (“YES”), the method 700 continues, at 708, where a set operation is applied to the overlapping portions. Set operations include an intersection, a union, and a subtraction, or another Boolean function to be performed on the overlapping data layers. The set operation that is performed, at 708, can be pre-defined by a user. In some embodiments, the user can be presented with a prompt to specify the set operation to be performed.

The method continues, at 710, where the overlapping portion with the set operation applied is displayed as a separate set of filtered data. The portions of the display mask that do not intersect or overlap another display mask are displayed in its original format. For example, if a display mask is created to display a weather layer and a traffic layer, the portion of the mask not overlapping another mask would show the weather layer and the traffic layer.

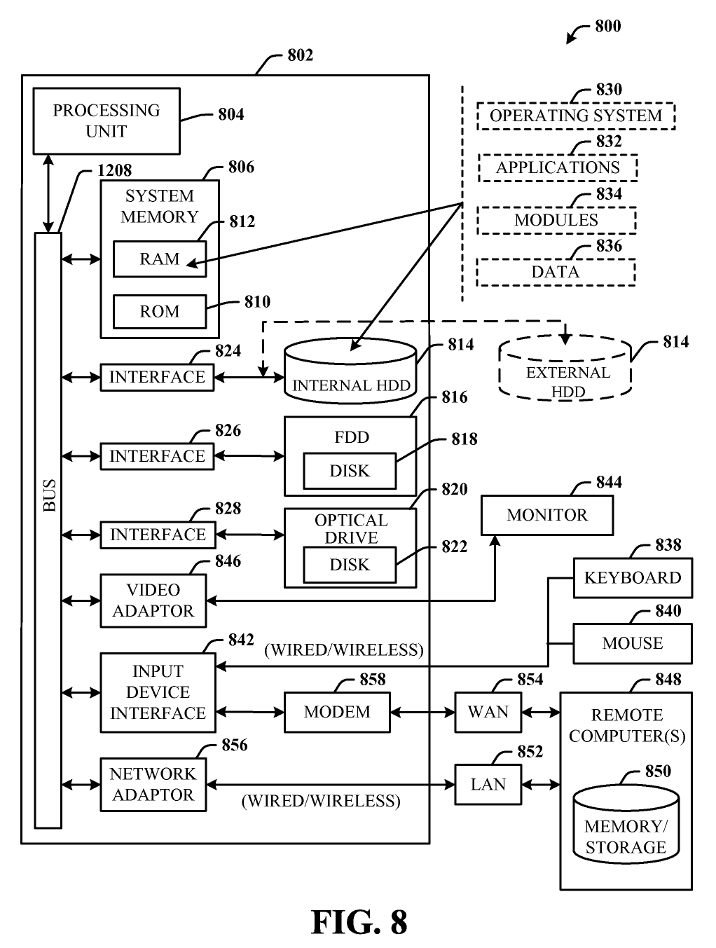

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g. EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various embodiments can be implemented with various commercially available operating systems or combinations of operating systems.

A user can enter commands and information into the computer 802 through one or more wired/wireless input devices, e.g. a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 through an interface, such as a video adapter 846. In addition to the monitor 844, a computer typically includes other peripheral output devices (not shown), such as speakers, printers, etc.

The computer 802 may operate in a networked environment using logical connections through wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g. a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 through the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

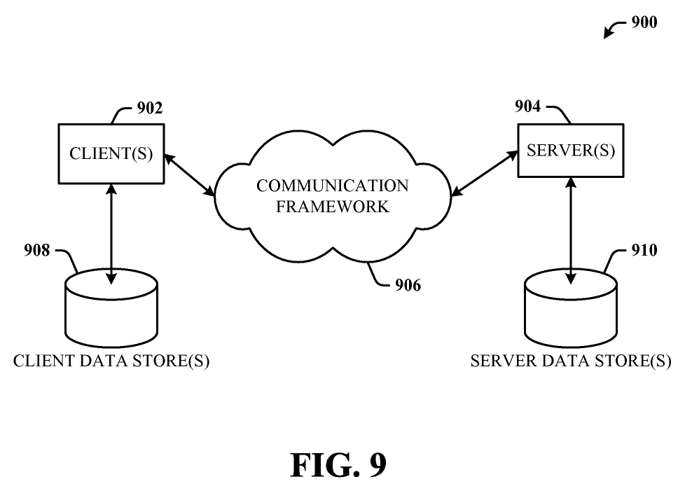

Referring now to FIG. 9, there is illustrated a schematic block diagram of an exemplary computing environment 900 in accordance with the various embodiments. The system 900 includes one or more client(s) 902. The client(s) 902 can be hardware and/or software (e.g., threads, processes, computing devices). The client(s) 902 can house cookie(s) and/or associated contextual information by employing the various embodiments, for example.

The system 900 also includes one or more server(s) 904. The server(s) 904 can also be hardware and/or software (e.g. threads, processes, computing devices). The servers 904 can house threads to perform transformations by employing the various embodiments, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g. a global communication network such as the Internet) that can be employed to facilitate communications between the client(s) 902 and the server(s) 904.

Communications can be facilitated through a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g. compact disk (CD), digital versatile disk (DVD) . . . smart cards, and flash memory devices (e.g. card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for layering data on a mapping application, comprising:
an overlay component that overlays at least a portion of a first set of filtered data with at least a portion of at least a second set of filtered data;
an optimization component that applies a set operation to the overlaid portion of the first set of filtered data and the at least a second set of filtered data; and
a render component that renders data in the overlapping portion as a function of the set operation.

2. The system of claim 1, the set operation is one of a union, a difference, and an intersection.

3. The system of claim 1, the first set of filtered data and the at least a second set of filtered data are displayed as an overlay on a mapping application.

4. The system of claim 1, the first and second sets of filtered data comprising separate data layers.

5. The system of claim 1, the optimization component applies a temporal setting independently to the first set of filtered data and the second set of filtered data.

6. The system of claim 1, further comprising a filter component that assigns at least one data layer to each set of filtered data.

7. The system of claim 6, the filter component maintains each set of filtered data in a storage media on a client machine.

8. The system of claim 1, the data rendered as a function of the set operation creates a third set of filtered data.

9. The system of claim 1, further comprising an input component that accepts a user-defined set operation to apply to the overlapping portions.

10. A method for displaying layered data, comprising:
identifying a first set of layered data and at least a second set of layered data;
applying a set operation to an intersection of the first set of layered data and the at least a second set of layered data; and
displaying the intersection as a separate set of layered data based in part on the applied set operation.

11. The method of claim 10, further comprising displaying the first and second set of layered data on a layered application.

12. The method of claim 10, after identifying the first and second sets of layered data further comprising: determining if at least a portion of the first set of layered data overlaps at least a portion of the second set of layered data.

13. The method of claim 10, further comprising: retaining the first set of layered data and the at least a second of layered data in a retrievable format.

14. The method of claim 10, further comprising:
determining if at least a first portion of the first set of layered data intersects at least a second portion the second set of layered data; and
removing the set operation from the intersection when it is determined that the at least a first portion does not intersect the at least a second portion.

15. The method of claim 10, the set operation is a Boolean function.

16. The method of claim 10, the set operation is defined by a user.

17. A computer executable system that provides layered data in a mapping application, comprising:
computer implemented means for defining a first display mask and at least a second display mask;
computer implemented means for determining if at least a subset of the first display mask and a subset of the second display mask create an overlapping portion; and
computer implemented means for applying a set operation to the overlapping portion.

18. The system of claim 17, further comprising computer implemented means for rendering the applied set operation in the overlapping portion as a separate display mask.

19. The system of claim 17, further comprising:
computer implemented means identifying when the subset of the first and second display masks do not overlap; and
computer implemented means for removing the set operation.

20. The system of claim 17, further comprising computer implemented means for receiving a set operation to apply to the overlapping portions of the first and second display masks.
